(19) United States
(12) Patent Application Publication
(10) Pub. No.: US 2025/0323358 A1
(43) Pub. Date: Oct. 16, 2025

(54) SECONDARY BATTERY

(71) Applicant: Samsung SDI Co., Ltd., Yongin-si (KR)

(72) Inventor: Jea Woan Lee, Yongin-si (KR)

(73) Assignee: Samsung SDI Co., Ltd., Yongin-si (KR)

(21) Appl. No.: 18/905,326

(22) Filed: Oct. 3, 2024

(30) Foreign Application Priority Data
Apr. 11, 2024 (KR) 10-2024-0048518

(51) Int. Cl. H01M 50/167; H01M 50/103; H01M 50/15; H01M 50/169; H01M 50/531; H01M 50/55

(52) U.S. Cl. CPC H01M 50/167; H01M 50/103; H01M 50/15; H01M 50/169; H01M 50/531; H01M 50/55; H01M 2220/20

(57) ABSTRACT

Embodiments relates a secondary battery. The secondary battery includes an electrode assembly, a case configured to accommodate the electrode assembly and having one open surface, a plate-shaped cover coupled to the open surface of the case, a first terminal provided on a second surface of the case, other than the open surface, and electrically connected to the electrode assembly, a second terminal provided to be spaced apart from the first terminal and electrically connected to the electrode assembly, and an insulating member configured to insulate the first terminal from the case. The cover is coupled to the case in a state of being inserted into the case. According to embodiments, a coupling structure between a case and a cover of a small secondary battery improves sealability after liquid injection. The coupling structure minimizes a dead space. As the dead space is reduced, the capacity of the secondary battery may increase.

### CROSS-REFERENCE TO RELATED APPLICATIONS

This present application claims priority to and the benefit under 35 U.S.C. § 119(a)-(d) of Korean Patent Application No. 10-2024-0048518, filed on Apr. 11, 2024, in the Korean Intellectual Property Office, the entire disclosure of which is incorporated herein by reference.

### FIELD

Embodiments relate to a secondary battery.

### BACKGROUND

Unlike primary batteries that are not designed to be (re) charged, secondary (or rechargeable) batteries are batteries that are designed to be discharged and recharged. Low-capacity secondary batteries are used in portable small electronic devices, such as smart phones, feature phones, notebook (laptop) computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above-described information disclosed in the technology that serves as the background of the present disclosure is only for improving understanding of the background of the present disclosure and thus may include information that does not constitute the related art.

### SUMMARY

Aspects of some embodiments of the present disclosure provide a secondary battery having an improved coupling structure of a case and a cover and a method for manufacturing the secondary battery.

These and other aspects and features of the present disclosure will be described in or will be apparent from the following description of embodiments of the present disclosure.

According to some embodiments, a secondary battery includes: an electrode assembly; a case configured to accommodate the electrode assembly and having one open surface; a plate-shaped cover coupled to the open surface of the case; a first terminal provided on a second surface of the case, other than the open surface, and electrically connected to the electrode assembly; a second terminal provided to be spaced apart from the first terminal and electrically connected to the electrode assembly; and an insulating member configured to insulate the first terminal from the case, wherein the cover is coupled to the case in a state of being inserted into the case.

The cover may have a size less than that of the open surface of the case.

An edge of the case may be pressed in the state in which the cover is inserted so that the case is in close contact with the cover.

The cover may be laser-welded to the case in the state in which the edge of the case is in close contact with the cover.

A surface of the edge of the case may protrude further outward than a surface of the cover.

The cover may include a stepped portion that is bent to be stepped from the surface of the cover so that the edge of the case is seated.

The edge of the case may protrude further outward than the stepped portion.

The edge of the case may be disposed at a same height as the surface of the cover.

The surface of the cover may protrude further outward than the edge of the case.

The electrode assembly may include a first electrode plate provided with a first electrode tab and a second electrode plate provided with a second electrode tab, wherein the first electrode tab may be electrically connected to the first terminal, and the second electrode tab may be electrically connected to the second terminal.

The second electrode tab may be provided on a portion of the case and/or coupled to the case.

The case may have a hexahedral shape so that one of two long sides of the case comprises the open surface so that the cover can be inserted therein, and the first terminal and the second terminal may be provided on one of a plurality of short sides of the case.

The plurality of short sides of the case may be in close contact with the cover.

According to some embodiments, a method for manufacturing a secondary battery includes: disposing a case so that an open surface of the case faces upward; inserting an electrode assembly into the case; pressing an edge of the case using a first crimping jig to bend the edge of the case; pressing the edge of the case using a second crimping jig so that the edge of the case is in close contact with the cover; and welding the case to the cover in the state in which the edge of the case is in close contact with the cover.

The cover may have a size less than that of the open surface of the case.

The case may have a hexahedral shape so that one of the two long sides of the case comprises the open surface so that the cover can be inserted therein, and an end of each of a plurality of short sides of the case may be in close contact with the cover.

A surface of the edge of the case may protrude further outward than a surface of the cover.

The cover may include a stepped portion that is bent to be stepped from the surface of the cover so as to be in close contact with an end of one of the plurality of short sides.

A surface of the one of the plurality of short sides may protrude further outward than the stepped portion, and the surface of the cover may be disposed at the same line as the surface of the short side or protrudes outward than the surface of the short side.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a perspective view of a secondary battery according to embodiments;

FIG. 2 illustrates a longitudinal cross-sectional view of the secondary battery of FIG. 1;

FIG. 3 illustrates a schematic side cross-sectional view of an electrode assembly of the secondary battery of FIG. 1;

FIG. 4 illustrates a schematic view of a process of manufacturing an exemplary secondary battery;

FIG. 5 illustrates a schematic cross-sectional view of the secondary battery manufactured by the manufacturing process of FIG. 4;

FIG. 6 illustrates a schematic view of a process of manufacturing an exemplary secondary battery;

FIG. 7 illustrates a schematic cross-sectional view of the secondary battery manufactured by the manufacturing process of FIG. 6;

FIG. 8 is a schematic view of a smartphone on which the secondary battery is mounted according to embodiments.

FIGS. 9 and 10 are perspective views showing a battery pack including an exemplary secondary battery according to the present invention.

FIGS. 11 and 12 are perspective and side views of a vehicle including an exemplary battery pack according to the present invention.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Additionally, in order to facilitate understanding of the invention, the attached drawings are not drawn to scale and the dimensions of some components may be exaggerated. Additionally, the same reference numbers may be assigned to the same components in different embodiments.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the disclosure.

Hereinafter, a secondary battery according to embodiments will be described in detail with reference to the accompanying drawings.

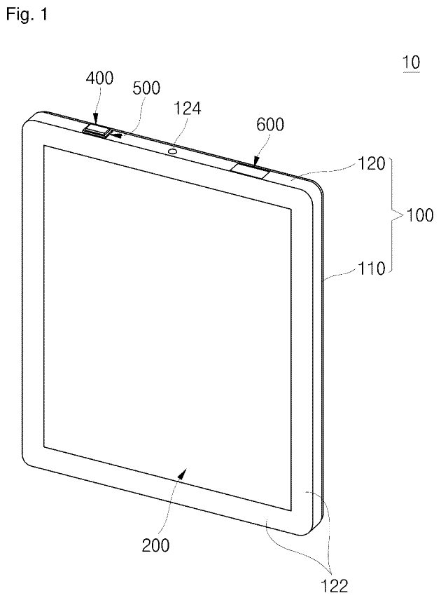

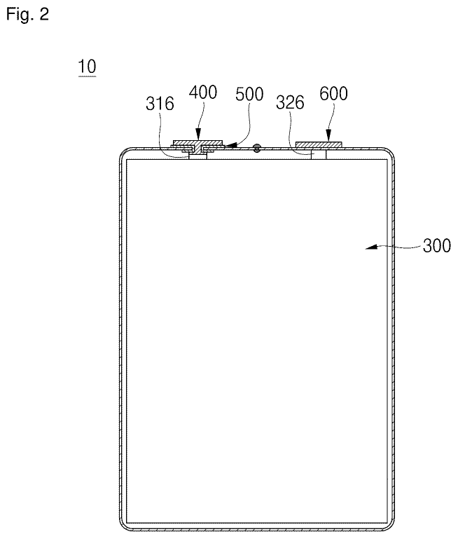

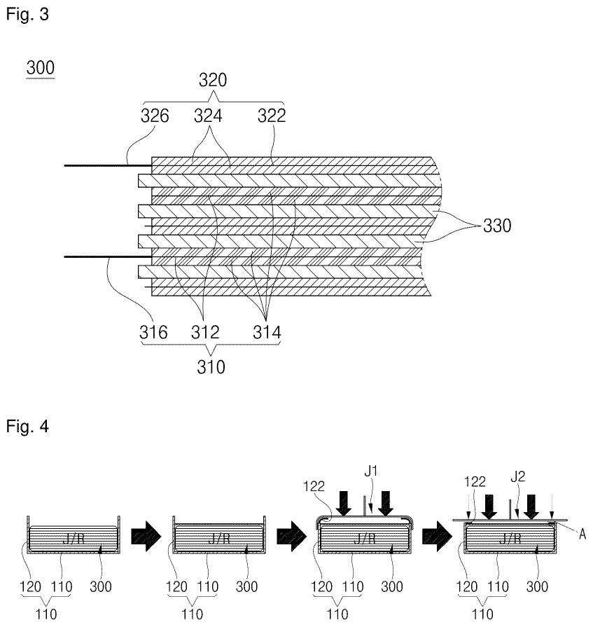

FIG. 1 illustrates a perspective view of a secondary battery according to embodiments. FIG. 2 illustrates a longitudinal cross-sectional view of the secondary battery of FIG. 1. FIG. 3 illustrates a schematic side cross-sectional view of an electrode assembly of the secondary battery of FIG. 1.

Referring to FIGS. 1 to 3, a secondary battery 10 according to embodiments may include a case 100 and a cover 200, an electrode assembly 300 accommodated in the case 100, a first terminal 400 and a second terminal 600, which are provided on the case 100, and an insulating member 500 configured to insulate the first terminal 400.

The case 100 may have a rectangular hexahedral shape or a rectangular parallelepiped shape with one surface opened. The case 100 may have a pair of long sides 110 (front and rear surfaces in FIG. 1) and four short sides 120 (top and bottom surfaces and left and right surfaces in FIG. 1). The above-described one opened surface may be one of the long sides 110. For example, the opened surface may be the front surface in FIG. 1. The cover 200 may be coupled to the opened surface of the case 100. The first terminal 400, the second terminal 600, and the insulating member 500 described above may be provided on one of the short sides 120. For example, the first terminal 400, the second terminal 600, and the insulating member 500 may be disposed on the short surface 120, which is the top surface in FIG. 1. A liquid injection hole 124 which is spaced apart from the first terminal 400 and the second terminal 600 and through which an electrolyte is injected may pass through the short side 120 that is the top surface. The liquid injection hole 124 may be closed with a pin or a ball, or the like, after liquid injection. In some embodiments, the case 100 may include or be referred to as a can, a housing, and/or an exterior material. The case 100 may be made of steel, nickel-plated steel or a steel alloy, and/or stainless steel (SUS). After the electrode assembly 300 is accommodated in the case 100, the cover 200 may be coupled to the case 100.

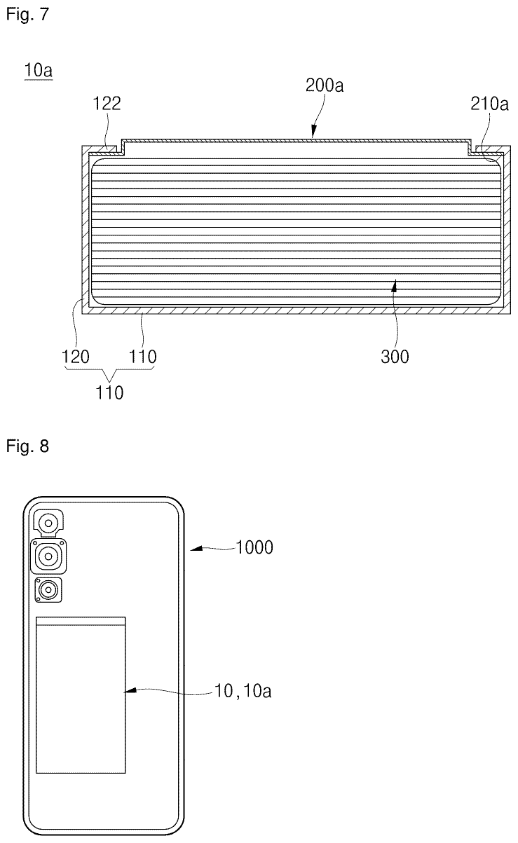

The cover 200 may be a square or rectangular plate corresponding to the opened one surface of the case 100. In some embodiments, a cover 200a may include a stepped portion 210a of which an edge is vertically bent to be stepped (as will be described further in FIGS. 6 and 7). The cover 200 may be made of the same material as the case 100. The cover 200 may have a size less than that of the opened surface of the case 100 and then be inserted into the case 100. Thereafter, the cover 200 may be primarily fixed by crimping and then secondarily fixed by welding. In some embodiments, the cover 200 may be coupled to the case 100 by laser welding. A coupling process of the case 100 and the cover 200 will be described later.

The electrode assembly 300 may be accommodated in the case 100 together with the electrolyte. The electrode assembly 300 may include or be referred to as an electrode group, an electrode body, or a jelly roll. The electrode assembly 300 may include a first electrode plate 310 and a second electrode plate 320, and a separator 330 disposed between the first electrode plate 310 and the second electrode plate 320. In the electrode assembly 300, the first electrode plate 310, the separator 330, and the second electrode plate 320 are stacked in a stack shape or wound in a jelly-roll shape. In some embodiments, if the electrode assembly 300 is stacked or wound, the separator 330 or the second electrode plate 320 may be placed at the outermost side. The case 100 and the electrode assembly 300 may be electrically insulated from each other. In some embodiments, the first electrode plate 310 may be a positive electrode plate, and the second electrode plate 320 may be a negative electrode plate, or vice versa, but in this embodiment, the description will be based on the case that the first electrode plate 310 is the positive electrode plate.

The first electrode plate 310 may include a first base material 312 that is metal foil such as aluminum or an aluminum alloy, and a first active material layer 314 provided on at least one surface of the first base material 312. In some embodiments, the first electrode plate 310 may further include a first non-coating portion that is not provided with the first active material layer 314. The first non-coating portion may be provided on one end of the first base material 312. The first non-coating portion may be notched in a certain shape to protrude outward from one end of the first base material 312. The protruding portion may be referred to as a first electrode tab 316. The first electrode tab 316 may be electrically connected to the first terminal 400, which will be described later.

Because the first electrode plate 310 is the positive electrode plate, the first active material layer 314 may include transition metal oxide. Meanwhile, as the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiaA1-bXbO2-cDc (0.90≤a≤1.8, 0≤b≤0.5, 0≤c≤0.05); LiaMn2-bXbO4-cDc (0.90≤a≤1.8, 0≤b≤0.5, 0≤c≤0.05); LiaNi1-b-cCobXcO2-aDa (0.90≤a≤1.8, 0≤b≤0.5, 0≤c≤0.5, 0<α≤2); LiaNi1-b-cMnbXcO2-αDα (0.90≤a≤1.8, 0≤b≤0.5, 0≤c≤0.5, 0<α<2); LiaNibCocL1dGeO2 (0.90≤a≤1.8, 0≤b≤0.9, 0≤c≤0.5, 0≤d≤0.5, 0≤e≤0.1); LiaNiGbO2 (0.90≤a≤1.8, 0.001≤b≤0.1); LiaCoGbO2 (0.90≤a≤1.8, 0.001≤b≤0.1); LiaMn1-bGbO2 (0.90≤a≤1.8, 0.001≤b≤0.1); LiaMn2GbO4 (0.90≤a≤1.8, 0.001≤b≤0.1); LiaMn1-gGgPO4 (0.90≤a≤1.8, 0≤g≤0.5); Li(3-f) Fe2(PO4)3 (0≤f≤2); and LiaFePO4 (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The second electrode plate 320 may include a second base material 322 that is metal foil such as copper, a copper alloy, nickel, or a nickel alloy, and a second active material layer 324 provided on at least one surface of the second base material 322. In some embodiments, the second electrode plate 320 may further include a second non-coating portion that is not provided with the second active material layer 324. The second non-coating portion may be provided on one end of the second base material 322. The second non-coating portion may be notched in a certain shape to protrude outward from one end of the second base material 322. The protruding portion may be referred to as a second electrode tab 326. The second electrode tab 326 may be electrically connected to the second terminal 600, which will be described herein.

Because the second electrode plate 320 is the negative electrode plate, the second active material layer 324 may include graphite and/or silicon. The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator 330 may be disposed between the first electrode plate 310 and the second electrode plate 320 to prevent short circuit and enable movement of lithium ions. The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and combinations thereof but is not limited thereto.

The organic material and the inorganic material may be mixed in one coating layer or may be in the form of a coating layer containing an organic material and a coating layer containing an inorganic material that are laminated on each other.

Meanwhile, the above-described first electrode tab 316 and second electrode tab 326 may be disposed toward the first terminal 400 and the second terminal 600. In some embodiments, the first electrode tab 316 and the second electrode tab 326 may be spaced apart from each other. For example, a direction in which the first electrode tab 316 and the second electrode tab 326 are disposed may be defined as an upper side of the electrode assembly 300 and the top surface of the case 100. However, instead of the first electrode tab 316 and the second electrode tab 326, in some embodiments, the above-described first non-coating portion and second non-coating portion may be electrically connected to the first terminal 400 and the second terminal 600, respectively, using separate lead tabs.

The first terminal 400 may be electrically connected to the first electrode tab 316 and may be insulated from the case 100 by the insulating member 500. In some embodiments, the first terminal 400 may have a hexahedral shape. The first terminal 400 may be inserted through a terminal hole defined in the case 100. The first terminal 400 may be partially disposed inside the case 100 and partially exposed to the outside of the case 100. A lower end of the first terminal 400 may be connected to the first electrode tab 316 and coupled by welding or the like.

The insulating member 500 may include or be referred to as a gasket or an insulator. The insulating member 500 may be made of an insulating material such as rubber or silicon. The insulating member 500 may be provided integrally with portions disposed at the outside and inside of the case 100 and within the terminal hole, or may be provided separately.

The second terminal 600 may be electrically connected to the case 100 or may be provided on a partial area of the case 100. For example, if the second terminal 600 is provided separately, the second terminal 600 may have a hexahedral shape. The second terminal 600 may be inserted to pass through the terminal hole defined in the case 100. The second terminal 600 may be partially disposed inside the case 100 and partially exposed to the outside of the case 100. A lower end of the second terminal 600 may be connected to the second electrode tab 326 and coupled by welding or the like. In other embodiments, if the second terminal 600 is a partial area of the case 100, the partial area of the case 100 may be electrically connected to the second electrode tab 326 by welding or the like.

As described above, after the electrode assembly 300 is inserted into the case 100 and connected to the first terminal 400 and the second terminal 600, the cover 200 may be coupled to the case 100. Thereafter, the electrolyte may be injected through the liquid injection hole 124, and the liquid injection hole 124 may be closed.

Hereinafter, a process for coupling the case 100 to the cover 200 and exemplary secondary batteries resulting from the process will be described.

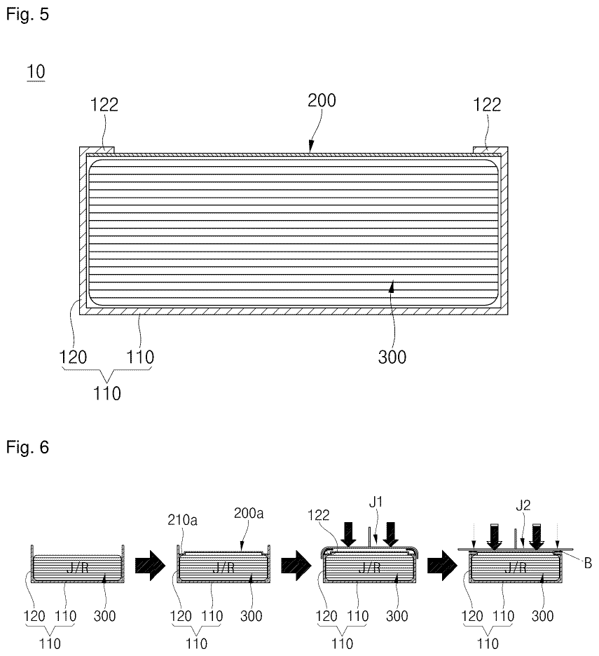

FIG. 4 illustrates a schematic view of a process of manufacturing an exemplary secondary battery. FIG. 5 illustrates a schematic cross-sectional view of the secondary battery manufactured by the manufacturing process of FIG. 4.

Referring to FIG. 4, in some manufacturing processes, the electrode assembly 300 may be inserted through an opened portion of a case 100. Thereafter, a cover 200 may be inserted into the case 100 to cover the electrode assembly 300. Because the cover 200 has a size less than that of the case 100, the cover 200 may be completely inserted into the case 100. To insulate the cover 200 from the electrode assembly 300, an insulating tape may be attached to the outermost portion of the electrode assembly 300, and/or the electrode assembly 300 may be wrapped with an insulating material. In some embodiments, the insulating tape may be attached to a surface on which the cover 200 is in contact with the electrode assembly 300.

After inserting the cover 200 into the case 100, the case 100 may be pressed using a primary crimping jig J1. A pressing direction may be indicated by an arrow in FIG. 4. The primary crimping jig J1 may have a curved shape of which a portion that is in contact with the case 100 is inclined downward. Therefore, if the primary crimping jig J1 presses four short sides 120 of the case 100, the short sides 120 may be bent toward the inside of the case 100. For this, with reference to FIG. 4, a vertical height of the short side 120 has to be greater than a thickness of the electrode assembly 300. Thereafter, the case 100 may be pressed using a secondary crimping jig J2 so that the short side 120 and the cover 200 are in contact with each other. If edges of the short side 120 and the cover 200 are in close contact with each other, welding may be performed along a contact area between the short side 120 and the cover 200 while maintaining the pressed state. For this, although not shown in the drawing, the secondary crimping jig J2 may be provided with a welding hole for the welding. If the secondary crimping jig J2 is viewed from the top, a portion of the contact area or an entire contact area between the short side 120 and the cover 200 may be exposed through the welding hole (corresponding area of which is indicated by reference symbol A in FIG. 4). The short side 120 and the cover 200 may be welded and fixed along the welding hole through laser welding, or the like. Thereafter, the electrolyte may be injected through the liquid injection hole 124, and the liquid injection hole 124 may be blocked. A secondary battery 10 which may be manufactured through the above-described manufacturing process is illustrated in FIG. 5. Referring to FIG. 5, because the short side 120 of the case 100 is bent to fix the cover 200, a portion of the short side 120 may be placed on the cover 200. Because welding is performed at a portion that is bent and in close contact with a top surface of the cover 200, the portion may be defined as a welded portion 122. Because the welded portion 122 is placed on the cover 200, a top surface of the welded portion 122 may protrude outward than the top surface of the cover 200. In some embodiments, in FIG. 5, a height of the top surface of the welded portion 122 may be disposed higher than a height of the top surface of the cover 200.

FIG. 6 illustrates a schematic view of a process of manufacturing an exemplary secondary battery. FIG. 7 illustrates a schematic cross-sectional view of the secondary battery manufactured by the manufacturing process of FIG. 6.

Referring to FIG. 6, in some manufacturing processes, an electrode assembly 300 may be inserted through an opened portion of a case 100. Thereafter, a cover 200 may be inserted into the case 100 to cover the electrode assembly 300. Because the cover 200 has a size less than that of the case 100, the cover 200 may be completely inserted into the case 100. To insulate the cover 200 from the electrode assembly 300, an insulating tape may be attached to the outermost portion of the electrode assembly 300, and/or the electrode assembly 300 may be wrapped with an insulating material. In some embodiments, the insulating tape may be attached to a surface on which the cover 200 is in contact with the electrode assembly 300. In some embodiments, a stepped portion 210a may be provided at an edge of the cover 200. The stepped portion 210a may have a stair shape in which the edge of the cover 200 is bent vertically downward and then bent vertically again.

After inserting the cover 200 into the case 100, the case 100 may be pressed using a primary crimping jig J1. A pressing direction may be indicated by an arrow in FIG. 6. The primary crimping jig J1 may have a curved shape of which a portion that is in contact with the case 100 is inclined downward. Therefore, if the primary crimping jig J1 presses four short sides 120 of the case 100, the short sides 120 may be bent toward the inside of the case 100. For this, with reference to FIG. 6, a vertical height of the short side 120 has to be greater than a thickness of the electrode assembly 300. Thereafter, the case 100 may be pressed using a secondary crimping jig J2 so that the short side 120 and the cover 200 are in contact with each other. An area on which the short side 120 and the cover 200 are in contact with each other may be a top surface of the stepped portion 210a. If the short side 120 and the stepped portion 210a of the cover 200 are in close contact with each other, welding may be performed along the stepped portion 210a of the short side 120 and the cover 200 while maintaining the pressed state. For this, although not shown in the drawing, the secondary crimping jig J2 may be provided with a welding hole for facilitating the welding. If the secondary crimping jig J2 is viewed from the top, a portion or whole of the short side 120 and the stepped portion 210a may be exposed through the welding hole (a corresponding area of which is indicated by reference symbol B in FIG. 6). The short side 120 and the cover 200 may be welded and fixed along the welding hole through laser welding, etc. Thereafter, the electrolyte may be injected through the liquid injection hole 124, and the liquid injection hole 124 may be blocked. A secondary battery 10 manufactured which may be through the above-described manufacturing process is illustrated in FIG. 7. Referring to FIG. 7, because the short side 120 of the case 100 is bent to fix the cover 200, a portion of the short side 120 may be placed on the stepped portion 210a of the cover 200. Because welding is performed at a portion at which the short side 120 is bent and in close contact with a top surface of the cover 200, the portion may be defined as a welded portion 122. Because the welded portion 122 is placed on the stepped portion 210a of the cover 200, a top surface of the welded portion 122 may protrude outward than the top surface of the stepped portion 210a of the cover 200. In some embodiments, in FIG. 7, a height of the top surface of the welded portion 122 may be disposed higher than a height of the top surface of the stepped portion 210a. However, the height of the top surface of the remaining area of the cover 200 except for the stepped portion 210a may be the same as the height of the welded portion 122 or may be disposed higher than the height of the welded portion 122.

As described above, the covers 200 and 200a may be primarily fixed to the case 100 using the primary crimping jig J1 and the secondary crimping jig J2, and the covers 200 and 200a may be secondarily fixed by welding. Therefore, sealability may be improved, and leakage of the electrolyte may be prevented if the electrolyte is injected after fixing the covers 200 and 200a. In some embodiments, because the covers 200 and 200a are smaller than the case 100, the typical flange structure provided on the case 100 for welding the covers 200 and 200a may be removed. In some embodiments, a dead space may be minimized, and capacity of the secondary battery 10 may increase by an amount of removed flange structure.

The secondary battery 10 according to the above-described embodiments may be used in a portable device 1000 such as a smartphone.

FIG. 8 is a schematic view of a smartphone on which the secondary battery is mounted according to embodiments.

As illustrated in FIG. 8, the secondary battery 10 according to embodiments described above may be a small battery mounted on a small portable device such as a smartphone 1000. In some embodiments, a thickness of a case and a cover of the exemplary secondary battery 10 may be about 0.1 T (mm). Because the capacity of the secondary battery 10 increases by removing the flange in the manufacturing process, the above-described secondary battery 10 may be a battery suitable for application to small portable devices.

In some embodiments, the secondary battery according to the above-described embodiments may be used to manufacture a battery pack by increasing its size. Reference numbers for components described below are reference numbers that are applied only to the corresponding drawings.

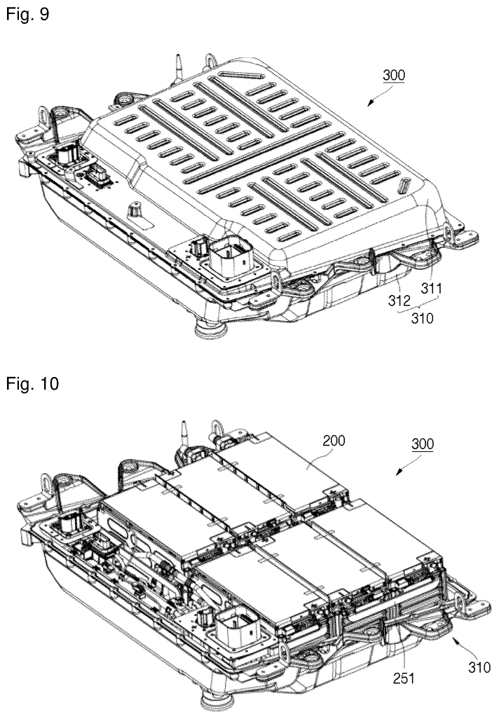

FIGS. 9 and 10 are perspective views showing a battery pack including an exemplary secondary battery 100.

Referring to FIGS. 9 and 10, the battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the drawings, for convenience, components such as busbars for the electrical connection of battery cells, cooling units, and external terminals are omitted. In some examples, the battery pack (300) may be installed in a vehicle. The vehicle can be, for example, an electric vehicle, a hybrid vehicle, or a plug-in hybrid vehicle. The vehicle may include a four-wheel vehicle or a two-wheel vehicle.

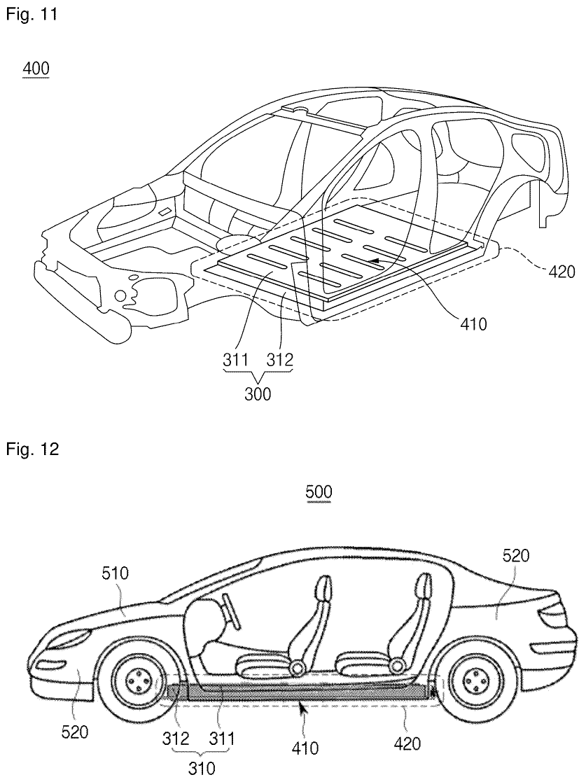

FIGS. 11 and 12 are perspective and side views of automobiles 400 and 500 including an exemplary battery pack 300 according to the present invention. In FIG. 11, a battery pack 300 may include a battery pack cover 311, which is a part of a vehicle underbody 410 and may correspond to the first housing, and a pack frame 312, which is disposed under the vehicle underbody 410 and may corresponding to the second housing. The battery pack cover 311 and the pack frame 312 may be integrally formed with a vehicle floor 420. The vehicle underbody 410 separates the inside and outside of a vehicle, and the pack frame 312 may be disposed outside the vehicle.

In FIG. 12, a vehicle 500 may be formed by combining additional parts, such as a hood 510 in front of the vehicle 500 and fenders 520 respectively located in the front and rear of the vehicle 500 to a vehicle body pars 400. The vehicle 500 may include the battery pack 300 including the battery pack cover 311 and the pack frame 312, and the battery pack 300 may be coupled to the vehicle body part 400.

According to the embodiments, the coupling structure between the case and the cover may be improved to improve the sealability after the liquid injection.

According to some embodiments, the coupling structure between the case and the cover may be improved to minimize the dead space. In some embodiments, as the dead space is reduced, the capacity of the secondary battery may increase.

However, aspects and features of the present disclosure are not limited to those described above, and other aspects and features not mentioned will be clearly understood by a person skilled in the art from the detailed description, described below.

Although the present disclosure has been described above with reference to limited embodiments and drawings, the present disclosure is not limited thereby and various modifications and variations may be made by a person having ordinary skill in the art to which the present disclosure pertains within the technical ideas of the present disclosure and the equivalent scope of the appended claims.

What is claimed is:

1. A secondary battery comprising:
an electrode assembly;
a case configured to accommodate the electrode assembly and having one open surface;
a plate-shaped cover coupled to the open surface of the case;
a first terminal provided on a second surface of the case, other than the open surface, and electrically connected to the electrode assembly;
a second terminal provided to be spaced apart from the first terminal and electrically connected to the electrode assembly; and
an insulating member configured to insulate the first terminal from the case,
wherein the cover is coupled to the case in a state of being inserted into the case.

2. The secondary battery as claimed in claim 1, wherein the cover has a size less than that of the open surface of the case.

3. The secondary battery as claimed in claim 2, wherein an edge of the case is pressed in the state in which the cover is inserted so that the case is in close contact with the cover.

4. The secondary battery as claimed in claim 3, wherein the cover is laser-welded to the case in the state in which the edge of the case is in close contact with the cover.

5. The secondary battery as claimed in claim 4, wherein a surface of the edge of the case protrudes further outward than a surface of the cover.

6. The secondary battery as claimed in claim 4, wherein the cover comprises a stepped portion that is bent to be stepped from the surface of the cover so that the edge of the case is seated.

7. The secondary battery as claimed in claim 6, wherein the edge of the case protrudes further outward than the stepped portion.

8. The secondary battery as claimed in claim 7, wherein the edge of the case is disposed at a same height as the surface of the cover.

9. The secondary battery as claimed in claim 7, wherein the surface of the cover protrudes further outward than the edge of the case.

10. The secondary battery as claimed in claim 1, wherein the electrode assembly comprises a first electrode plate provided with a first electrode tab and a second electrode plate provided with a second electrode tab,
wherein the first electrode tab is electrically connected to the first terminal, and the second electrode tab is electrically connected to the second terminal.

11. The secondary battery as claimed in claim 10, wherein the second electrode tab is provided on a portion of the case and/or coupled to the case.

12. The secondary battery as claimed in claim 11, wherein the case has a hexahedral shape so that one of two long sides of the case comprises the open surface so that the cover can be inserted therein, and
the first terminal and the second terminal are provided on one of a plurality of short sides of the case.

13. The secondary battery as claimed in claim 12, wherein the plurality of short sides of the case are in close contact with the cover.

14. A method for manufacturing a secondary battery, the method comprising:
disposing a case so that an open surface of the case faces upward;
inserting an electrode assembly into the case;
pressing an edge of the case using a first crimping jig to bend the edge of the case;
pressing the edge of the case using a second crimping jig so that the edge of the case is in close contact with the cover; and
welding the case to the cover in the state in which the edge of the case is in close contact with the cover.

15. The method as claimed in claim 14, wherein the cover has a size less than that of the open surface of the case.

16. The method as claimed in claim 15, wherein the case has a hexahedral shape so that one of two long sides of the case comprises the open surface so that the cover can be inserted therein, and
an end of each of a plurality of short sides of the case is in close contact with the cover.

17. The method as claimed in claim 16, wherein a surface of the edge of the case protrudes further outward than a surface of the cover.

18. The method as claimed in claim 16, wherein the cover comprises a stepped portion that is bent to be stepped from the surface of the cover so as to be in close contact with an end of one of the plurality of short sides.

19. The method as claimed in claim 18, wherein a surface of the one of the plurality of short sides protrudes further outward than the stepped portion, and
the surface of the cover is disposed at a same line as the surface of the short side or protrudes further outward than the surface of the one of the plurality of short sides.
